(19) United States
(12) Patent Application Publication
(10) Pub. No.: US 2012/0214424 A1
(43) Pub. Date: Aug. 23, 2012

(54) Single Input/Multiple Output (SIMO) or Multiple Input/Single Output (MISO) or Multiple Input/Multiple Output (MIMO) Antenna Module

(75) Inventors: Ming-Hao Yeh, Taipei City 111 (TW); Kuo-Fong Hung, Changhua City (TW)

(73) Assignee: MEDIATEK INC., Hsin-Chu (TW)

(21) Appl. No.: 13/032,713

(22) Filed: Feb. 23, 2011

(51) Int. Cl. H01Q 13/16

(52) U.S. Cl. 455/73

(57) ABSTRACT

An antenna module is provided. The antenna module includes a first slot antenna unit and a second slot antenna unit. The first slot antenna unit is coupled to a radio frequency (RF) unit. The second slot antenna unit is coupled to the RF unit. The first and second slot antenna units are embedded in a wireless communications dongle, and the wireless communications dongle operates as a modem to transmit or receive a wireless signal to or from a wireless telephony communications network for a computer via the first and second slot antenna units when the wireless communication dongle connects to the computer.

### BACKGROUND OF THE INVENTION

1. Field of the Invention

The present invention relates to a single input/multiple output (SIMO), a multiple input/single output (MISO), or a multiple input/multiple output (MIMO) antenna module, and in particular, relates to a SIMO, MISO, or MIMO antenna module with improved SAR value.

2. Description of the Related Art

A specific absorption rate (SAR) is a measure of the rate at which radio frequency (RF) energy is absorbed by a human body when exposed to radio-frequency electromagnetic fields. It is defined as the power absorbed per mass of tissue in units of Watts per kilogram. SAR is usually averaged either over a whole body, or over a small sample volume (typically 1 g or 10 g of tissue). The value cited is then the maximum level measured for the body part studied over the stated volume or mass. It may be calculated from the electric field within the tissue as:

$$S A R = \frac{σ {\vert E \vert}^{2}}{2 ρ} ,$$

where σ represents the sample electrical conductivity, |E| represents the magnitude of the electric field and ρ represents the sample density.

For a conventional mimo antenna module, decreasing the SAR value of the SIMO, MISO, or MIMO antenna module is difficult due to dimensional restrictions and limited antenna choices.

### BRIEF SUMMARY OF THE INVENTION

An antenna module is provided. The antenna module includes a first slot antenna unit and a second slot antenna unit. The first slot antenna unit is coupled to a radio frequency (RF) unit. The second slot antenna unit is coupled to the RF unit. The first and second slot antenna units are embedded in a wireless communications dongle, and the wireless communications dongle operates as a modem to transmit or receive a wireless signal to or from a wireless telephony communications network for a computer via the first and second slot antenna units when the wireless communication dongle connects to the computer.

Utilizing the antenna module of the embodiment with slot antenna units, the SAR value of the antenna module can be improved. Compared to conventional antenna modules with Planar Inverted-F Antenna (PIFA) antenna units, the SAR value of the antenna module of the embodiment is reduced by about 0.4.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a block diagram of a multiple input/single output (MISO) antenna module of a first embodiment of the invention when the single MISO antenna module is in a receiving mode;

FIG. 1B is a block diagram of the MISO antenna module of the first embodiment of the invention when the MISO antenna module is in a transmitting mode;

FIG. 2A is a perspective view of the first slot antenna unit and the second slot antenna unit for a single input/multiple output (SIMO), a MISO, or a multiple input/multiple output (MIMO) antenna module;

FIG. 2B is a top view of the first slot antenna unit and the second slot antenna unit for the SIMO/MISO/MIMO antenna module;

FIGS. 3A-3H show embodiments of the slot of the slot antenna unit;

FIG. 4A is a block diagram of a MIMO antenna module of a second embodiment of the invention when the MIMO antenna module is in a receiving mode;

FIG. 4B is a block diagram of the MIMO antenna module of the second embodiment of the invention when the MIMO antenna module is in a transmitting mode; and

FIG. 5 shows the SIMO/MISO/MIMO antenna module of the embodiment embedded in a portable electronic device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

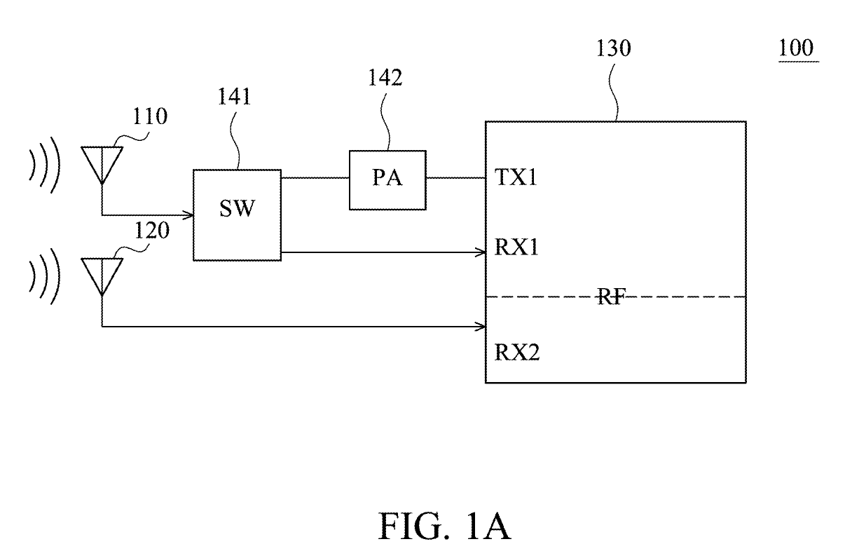

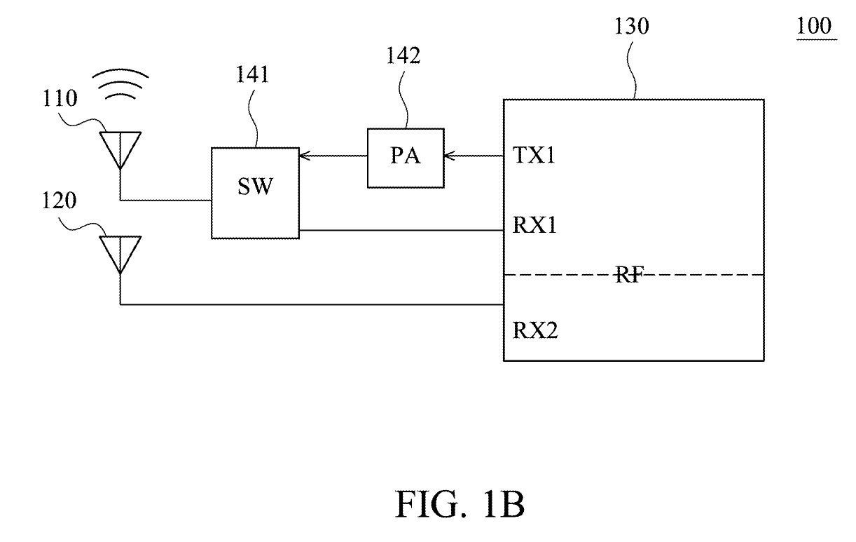

FIGS. 1A and 1B are block diagrams of an electronic apparatus 100 comprising a multiple input/single output (MISO) antenna module of a first embodiment of the invention. The MISO antenna module includes a radio frequency (RF) unit 130, a first slot antenna unit 110, a second slot antenna unit 120, a first switch device 141 and a first power amplifier (PA) 142. The RF unit 130 may receive an RF wireless signal, convert the received signal to a baseband signal, which is processed by a baseband unit, or receive a baseband signal from a baseband unit and convert the received signal to an RF wireless signal, which are later transmitted. The RF unit 130 may also comprise a plurality of hardware devices to perform radio frequency conversion. For example, the RF unit 130 may comprise a mixer to multiply the baseband signal with a carrier oscillated in a radio frequency of the wireless communications system, wherein the radio frequency may be 900 MHz, 1900 MHz or 2100 MHz utilized in Wideband Code Division Multiple Access (WCDMA) systems, or others depending on which radio access technology (RAT) is being used. The RF unit 130 comprises a first receiving port RX1, a second receiving port RX2 and a transmitting port TX1. The first slot antenna unit 110 is coupled to the first switch device 141, the first switch device 141 is selectively coupled to the first receiving port RX1 and the transmitting port TX1, and the first power amplifier 142 is coupled between the first transmitting port TX1 and the first switch device 141. The second slot antenna unit 120 is coupled to the second receiving port RX2. In a receiving mode as shown in FIG. 1A, the first switch device 141 switches the first antenna unit 110 to couple to the first receiving port RX1, then, the first slot antenna unit 110 receives a first receiving signal and the first receiving signal is passed to the first receiving port RX1, and the second slot antenna unit 120 receives a second receiving signal and the second receiving signal is passed to the second receiving port RX2. In a transmitting mode as shown in FIG. 1B, the first switch device 141 switches the first antenna unit 110 coupled to the transmitting port TX1, then, a transmitting signal is transmitted from the transmitting port TX1, amplified by the power amplifier 142, and emitted via the first slot antenna unit 110.

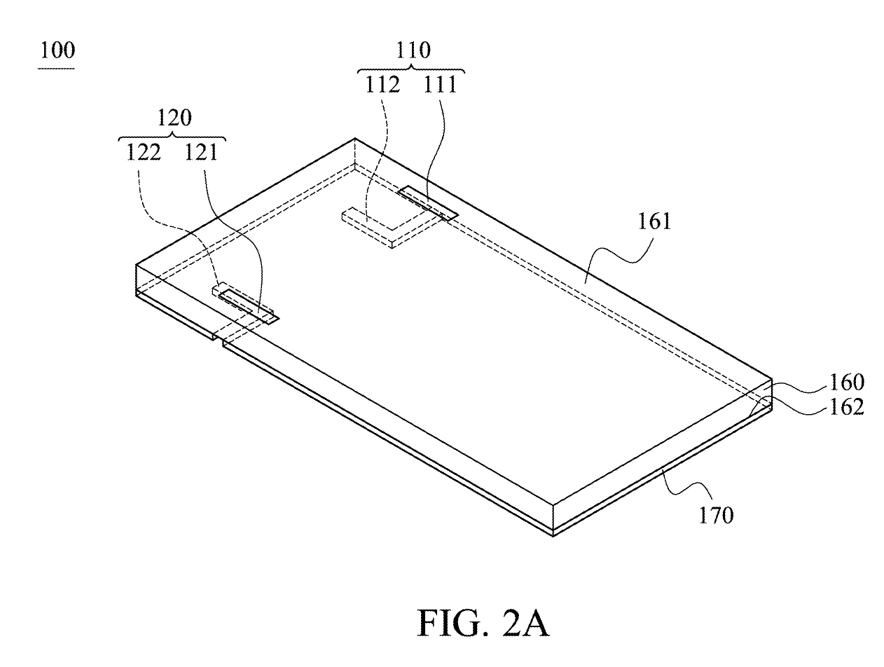

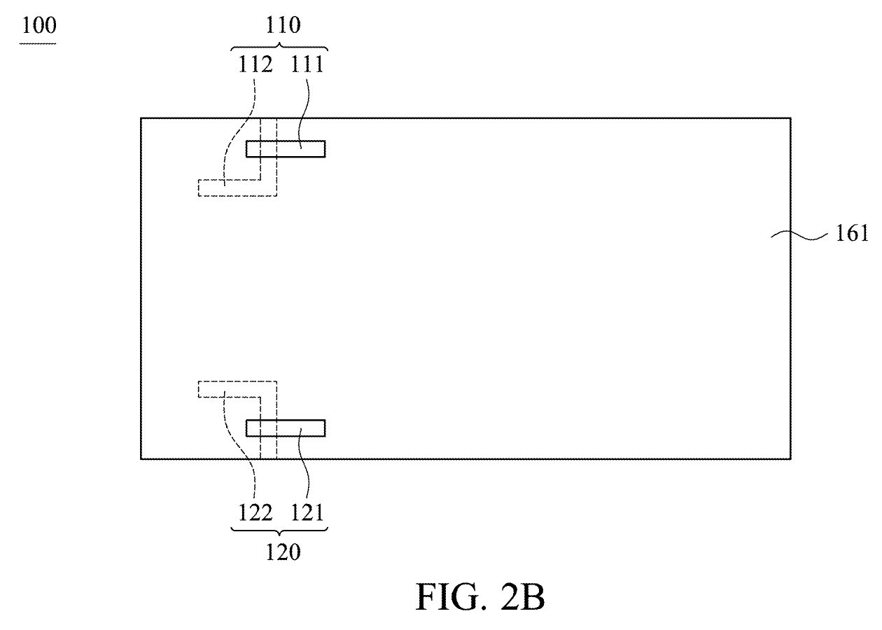

FIGS. 2A and 2B shows the first slot antenna unit and the second slot antenna unit of an electronic apparatus 100, wherein the electronic apparatus 100 further comprises a substrate 160 and a ground layer 170, wherein the RF unit (not shown), the ground layer 170, the first slot antenna unit 110 and the second slot antenna unit 120 are disposed on the substrate 160. The substrate 160 comprises a first surface 161 and a second surface 162, and the first surface 161 is opposite to the second surface 162, wherein the ground layer 170 is disposed on the second surface 162. The electronic apparatus 100 is equipped with a single input/multiple output (SIMO), a multiple input/single output (MISO), or a multiple input/multiple output (MIMO) antenna module to improve performance. When two transmitters and two or more receivers are used, two simultaneous data streams may be sent via the antenna module, which double the data rate. Multiple receivers alone with the antenna module allow greater distances between devices. For example, the IEEE 802.11n (Wi-Fi) wireless standard uses MIMO to increase speed to 100 Mbps and beyond, doubling at minimum the 802.11a and 11g rates. The antenna module may also be used in WiMAX (Worldwide Interoperability for Microwave Access) and LTE (Long Term Evolution) communications devices.

The first slot antenna unit 110 and the second slot antenna unit 120 may have the same structure or different structures. In the embodiment of FIGS. 2A and 2B, the first slot antenna unit 110 comprises a first feed conductor 111 and a first slot 112, the first slot 112 is formed in the ground element 170, the first feed conductor 111 is disposed on the first surface 161 and corresponds to the first slot 112, the second slot antenna unit 120 comprises a second feed conductor 121 and a second slot 122, the second slot 122 is formed in the ground element 170, and the second feed conductor 121 is disposed on the first surface 161 and corresponds to the second slot 122.

Utilizing the antenna module of the embodiment with slot antenna units, the SAR value of the antenna module can be improved. Compared to conventional antenna modules with Planar Inverted-F Antenna (PIFA) antenna units, the SAR value of the antenna module of the embodiment is reduced by about 0.4.

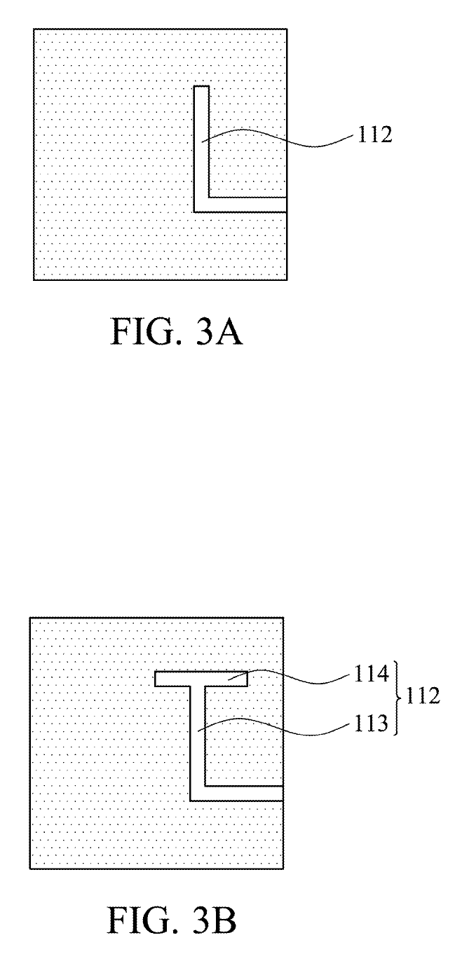

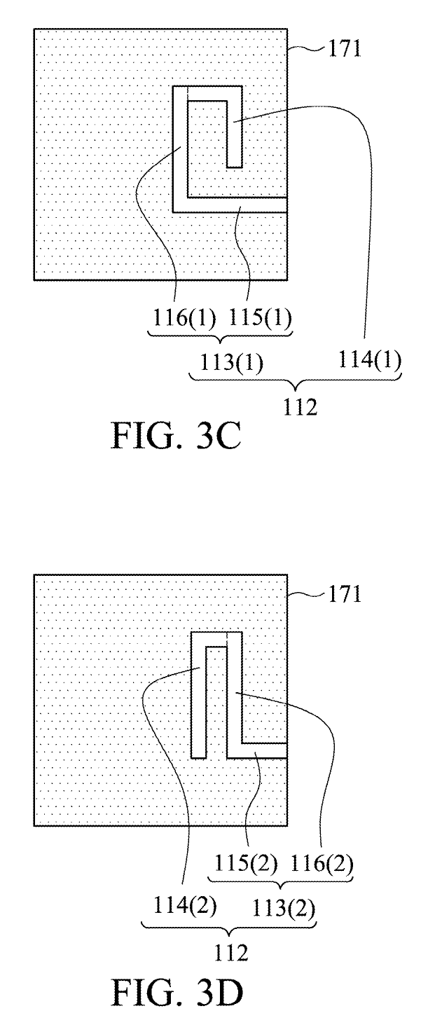

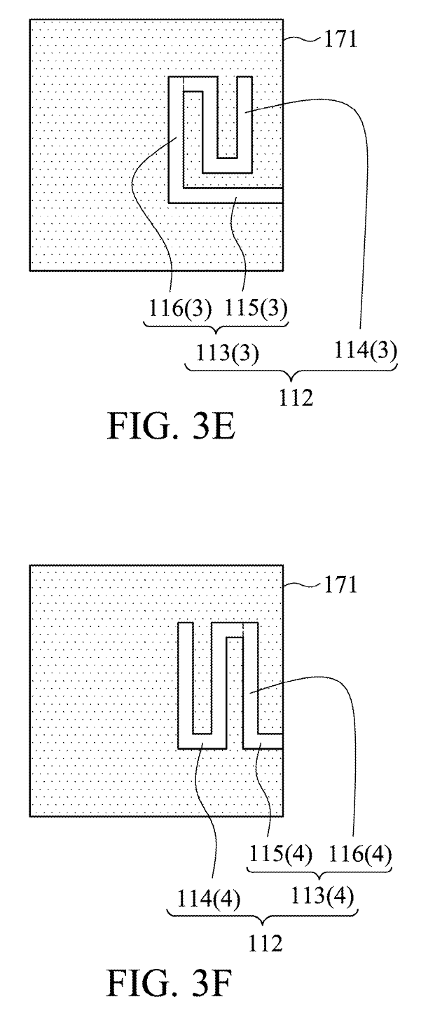

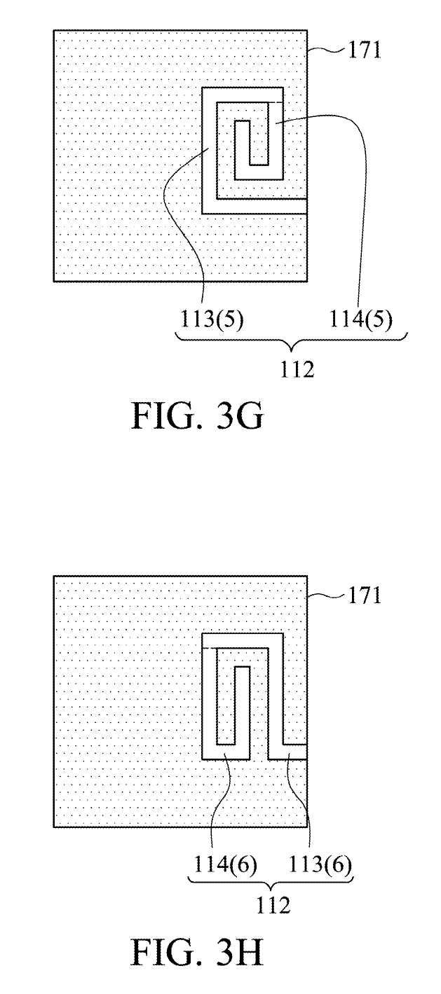

The slot patterns of the slot antenna units can be modified. The embodiments of the slots of the invention are described as taking a first slot antenna unit as an example. FIG. 3A shows an embodiment of the first slot 112, wherein the first slot 112 is L shaped. FIG. 3B shows another embodiment of the first slot 112, wherein the first slot 112 comprises a first portion 113 and a second portion 114, and the first portion 113 is L shaped, the second portion 114 is longitudinal, and the second portion 114 is connected to an end of the first portion 113.

FIG. 3C shows still another embodiment of the first slot 112, wherein the first slot comprises a first portion 113(1) and a second portion 114(1), and the first portion 113(1) is L shaped, the second portion 114(1) is L shaped. The first portion 113(1) comprises a first section 115(1) and a second section 116(1), and the first section 115(1) is connected to the second section 116(1) and perpendicular thereto. An end of the first section 115(1) is opened at a side 171 of the ground element, and an end of the second portion 114(1) is connected to an end of the second section 116(1). The second portion 114(1) is located between the second section 116(1) and the side 171 of the ground element.

FIG. 3D shows still another embodiment of the first slot 112, wherein the first slot comprises a first portion 113(2) and a second portion 114(2), and the first portion 113(2) is L shaped, the second portion 114(2) is L shaped. The first portion 113(2) comprises a first section 115(2) and a second section 116(2), and the first section 115(2) is connected to the second section 116(2) and perpendicular thereto. An end of the first section 115(2) is opened at a side 171 of the ground element, and an end of the second portion 114(2) is connected to an end of the second section 116(2). The second section 116(2) is located between the second portion 114(2) and the side 171 of the ground element.

FIG. 3E shows still another embodiment of the first slot 112, wherein the first slot comprises a first portion 113(3) and a second portion 114(3), and the first portion 113(3) is L shaped, the second portion 114(3) is U shaped. The first portion 113(3) comprises a first section 115(3) and a second section 116(3), and the first section 115(3) is connected to the second section 116(3) and perpendicular thereto. An end of the first section 115(3) is opened at a side 171 of the ground element, and an end of the second portion 114(3) is connected to an end of the second section 116(3). The second portion 114(3) is located between the second section 116(3) and the side 171 of the ground element.

FIG. 3F shows still another embodiment of the first slot 112, wherein the first slot comprises a first portion 113(4) and a second portion 114(4). The first portion 113(4) is L shaped, the second portion 114(4) is U shaped. The first portion 113(4) comprises a first section 115(4) and a second section 116(4), and the first section 115(4) is connected to the second section 116(4) and perpendicular thereto. An end of the first section 115(4) is opened at a side 171 of the ground element, and an end of the second portion 114(4) is connected to an end of the second section 116(4). The second section 116(4) is located between the second portion 114(4) and the side 171 of the ground element.

FIG. 3G shows still another embodiment of the first slot 112, wherein the first slot comprises a first portion 113(5) and a second portion 114(5), and the first portion 113(5) is U shaped, and the second portion 114(5) is U shaped. An end of the first portion 113 (5) is opened at a side 117 of the ground element, and an end of the second portion 114(5) is connected to the other end of the first portion 113 (5).

FIG. 3H shows still another embodiment of the first slot 112, wherein the first slot comprises a first portion 113(6) and a second portion 114(6), and the first portion 113(6) is lightning bolt shaped, and the second portion 114(6) is U shaped. An end of the first portion 113 (6) is opened at a side 117 of the ground element, and an end of the second portion 114(6) is connected to the other end of the first portion 113 (6).

Note that any of the slot antenna patterns illustrated in FIGS. 3A to 3H may be modified to be flipped right to left to form the second slot 122, and the invention cannot be limited thereto. Those skilled in the art may modify the slot patterns of the embodiments disclosed above to similar but different patterns, and the invention should not be limited thereto.

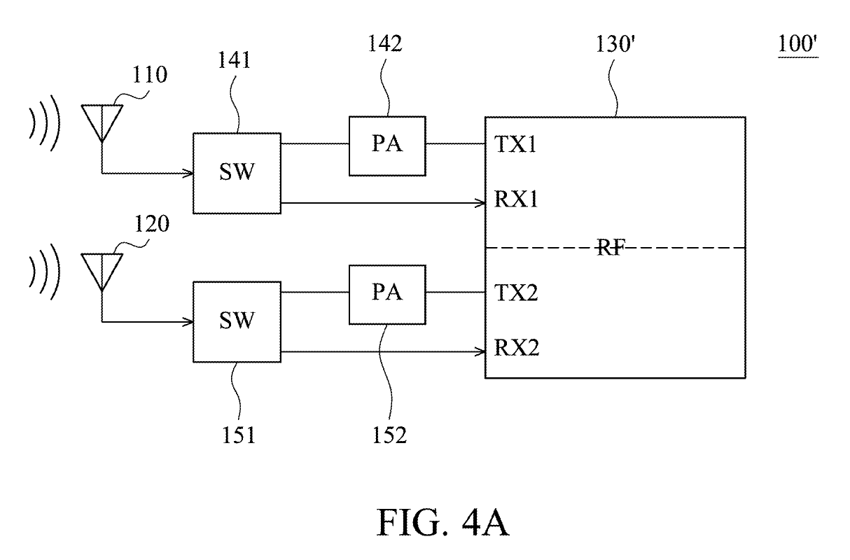

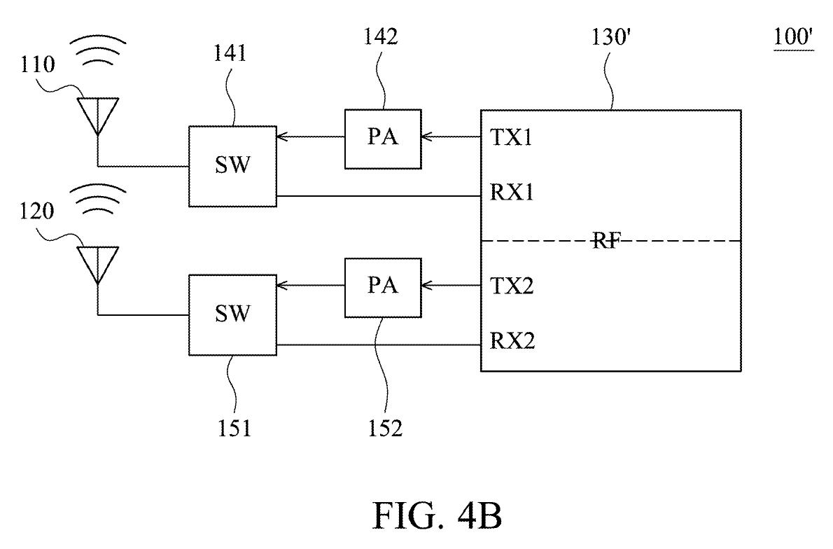

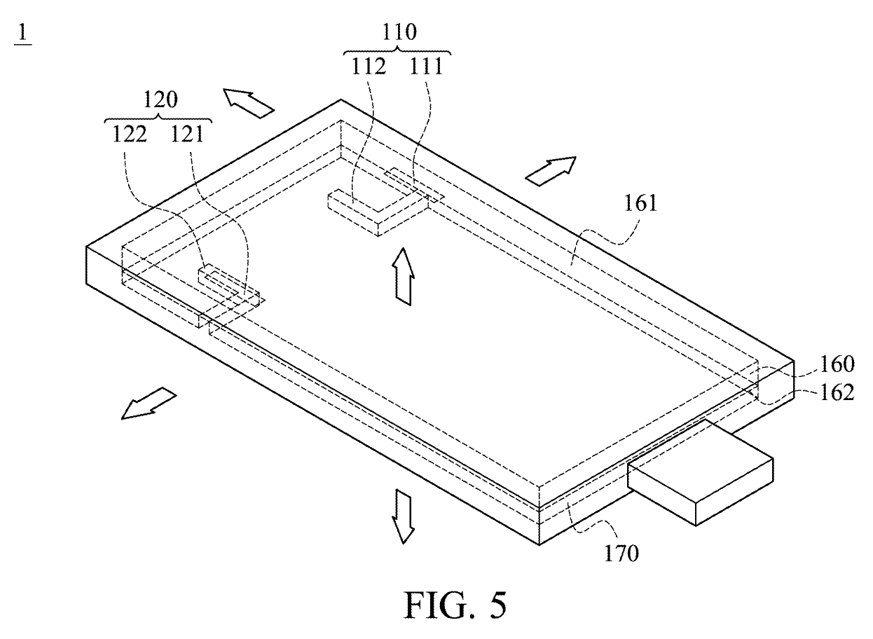

FIGS. 4A and 4B are block diagrams of an electronic apparatus 100′ comprising an MIMO antenna module of a second embodiment of the invention. The electronic apparatus 100′ includes an RF unit 130′, a first slot antenna unit 110, a second slot antenna unit 120, a first switch device 141 a first power amplifier (PA) 142, a second switch device 151 and a second power amplifier (PA) 152. The RF unit 130′ comprises a first receiving port RX1, a second receiving port RX2, a first transmitting port TX1 and a second transmitting port TX2. The RF unit 130′ operates like the RF unit 130 and detailed reference can be made to description of FIGS. 1A and 1B. The first slot antenna unit 110 is coupled to the first switch device 141, the first switch device 141 is selectively coupled to the first receiving port RX1 and the first transmitting port TX1, and the first power amplifier 142 is coupled between the first transmitting port TX1 and the first switch device 141. The second slot antenna unit 120 is coupled to the second switch device 151, the second switch device 151 is selectively coupled to the second receiving port RX2 and the second transmitting port TX2, and the second power amplifier 152 is coupled between the second transmitting port TX2 and the second switch device 151. In a receiving mode as shown in FIG. 4A, the first switch device 141 switches the first antenna unit 110 to couple to the first receiving port RX1, the second switch device 151 switches the second antenna unit 120 to couple to the second receiving port RX2, such that the first slot antenna unit 110 receives a first receiving signal and the first receiving signal is passed to the first receiving port RX1, and the second slot antenna unit 120 receives a second receiving signal and the second receiving signal is passed to the second receiving port RX2. In a transmitting mode as shown in FIG. 4B, the first switch device 141 switches the first antenna unit 110 to couple to the first transmitting port TX1, the second switch device 151 switches the second antenna unit 120 to couple to the second transmitting port TX2, such that a first transmitting signal is transmitted from the first transmitting port TX1, amplified by the first power amplifier 142, and emitted via the first slot antenna unit 110, and a second transmitting signal is transmitted from the second transmitting port TX2, amplified by the second power amplifier 152, and emitted via the second slot antenna unit 120. The data transmitted with the first transmitting signal can be the same or different from the data transmitted with the second transmitting signal. When the data transmitted with the first transmitting signal is the same with the data transmitted with the second transmitting signal, the MIMO antenna module improves output power. When the data transmitted with the first transmitting signal differs from the data transmitted with the second transmitting signal, the MIMO antenna module increases data transmission rate.

FIG. 5 shows the antenna module of the embodiments embedded in a portable electronic device 1. The antenna module of the embodiment may be embedded in a wireless communications dongle, such as a Wi-Fi, WCDMA, WiMAX or LTE dongle, or a similar but different device. The wireless communications dongle may further provide a universal serial bus (USB) interface to connect a personal computer, a notebook or a planar computer, or others. The wireless communications dongle operates as a modem when connecting to any kind of computers via the USB interface, and provides wireless communications services with a base station, a node-B, an advanced node-B, or others, in a wireless telephony communications network.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna module, comprising:
a first slot antenna unit, coupled to a radio frequency (RF) unit; and
a second slot antenna unit, coupled to the RF unit,
wherein the first and second slot antenna units are embedded in a wireless communications dongle, and the wireless communications dongle operates as a modem to transmit or receive a wireless signal to or from a wireless telephony communications network for a computer via the first and second slot antenna units when the wireless communication dongle connects to the computer.

2. The antenna module as claimed in claim 1, further comprising a substrate and a ground layer, wherein the RF unit, the ground layer, the first slot antenna unit and the second slot antenna unit are disposed on the substrate.

3. The antenna module as claimed in claim 2, wherein the substrate comprises a first surface and a second surface, and the first surface is opposite to the second surface, and the ground layer is disposed on the second surface, and the first slot antenna unit comprises a first feed conductor and a first slot, and the second slot antenna unit comprises a second feed conductor and a second slot, wherein the first slot and the second slot are formed in the ground element, the first feed conductor is disposed on the first surface and corresponding to the first slot, and the second feed conductor is disposed on the first surface and corresponding to the second slot.

4. The antenna module as claimed in claim 3, wherein the first or second slot is L shaped.

5. The antenna module as claimed in claim 3, wherein the first or second slot comprises a first portion and a second portion, and the first portion is L shaped, the second portion is longitudinal, and the second portion is connected to an end of the first portion.

6. The antenna module as claimed in claim 3, wherein the first or second slot comprises a first portion and a second portion, and the first portion is L shaped, the and second portion is L shaped, and the first portion comprises a first section and a second section, wherein the first section is connected to the second section and perpendicular thereto, and an end of the first section is opened at a side of the ground element, and an end of the second portion is connected to an end of the second section, and the second portion is located between the second section and the side of the ground element.

7. The antenna module as claimed in claim 3, wherein the first or second slot comprises a first portion and a second portion, and the first portion is L shaped, and the second portion is L shaped, and the first portion comprises a first section and a second section, wherein the first section is connected to the second section and perpendicular thereto, and an end of the first section is opened at a side of the ground element, and an end of the second portion is connected to an end of the second section, and the second section is located between the second portion and the side of the ground element.

8. The antenna module as claimed in claim 3, wherein the first or second slot comprises a first portion and a second portion, and the first portion is L shaped, and the second portion is U shaped, and the first portion comprises a first section and a second section, and the first section is connected to the second section and perpendicular thereto, wherein an end of the first section is opened at a side of the ground element, and an end of the second portion is connected to an end of the second section, and the second portion is located between the second section and the side of the ground element.

9. The antenna module as claimed in claim 3, wherein the first or second slot comprises a first portion and a second portion, and the first portion is L shaped, and the second portion is U shaped, and the first portion comprises a first section and a second section, wherein the first section is connected to the second section and perpendicular thereto, and an end of the first section is opened at a side of the ground element, and an end of the second portion is connected to an end of the second section, and the second section is located between the second portion and the side of the ground element.

10. The antenna module as claimed in claim 3, wherein the first or second slot comprises a first portion and a second portion, and the first portion is U shaped, and the second portion is U shaped, wherein an end of the first portion is opened at a side of the ground element, and an end of the second portion is connected to the other end of the first portion.

11. The antenna module as claimed in claim 3, wherein the first or second slot comprises a first portion and a second portion, and the first portion is lightning bolt shaped, and the second portion is U shaped, wherein the first portion comprises an end which is opened at a side of the ground element, and an end of the second portion is connected to the other end of the first portion.

12. The antenna module as claimed in claim 3, wherein the first or second feed conductor is longitudinal.

13. The antenna module as claimed in claim 1, wherein the first slot antenna unit couples a first receiving port of the RF unit, the second slot antenna unit couples a second receiving port of the RF unit, and in a receiving mode, the first slot antenna unit receives a wireless signal and the wireless signal is passed to the first receiving port and the second slot antenna unit receives the wireless signal and the wireless signal is passed to the second receiving port.

14. The mimo antenna module as claimed in claim 1, wherein the first slot antenna unit couples a first transmitting port of the RF unit, the second slot antenna unit couples a second transmitting port of the RF unit, and in a transmitting mode, a transmitting signal is transmitted from the first transmitting port and emitted via the first slot antenna unit and the transmitting signal is transmitted from the second transmitting port and emitted via the second slot antenna unit.

15. The antenna module as claimed in claim 1, wherein the first slot antenna unit couples a first receiving port of the RF unit, the second slot antenna unit couples a second receiving port of the RF unit, and in a receiving mode, the first slot antenna unit receives a first wireless signal and the first wireless signal is passed to the first receiving port and the second slot antenna unit receives a second wireless signal and the second wireless signal is passed to the second receiving port.

16. The mimo antenna module as claimed in claim 1, wherein the first slot antenna unit couples a first transmitting port of the RF unit, the second slot antenna unit couples a second transmitting port of the RF unit, and in a transmitting mode, a first transmitting signal is transmitted from the first transmitting port and emitted via the first slot antenna unit and a second transmitting signal is transmitted from the second transmitting port and emitted via the second slot antenna unit.
